(19) United States
(12) Patent Application Publication
(10) Pub. No.: US 2011/0170992 A1
(43) Pub. Date: Jul. 14, 2011

(54) Transport Apparatus

(76) Inventor: Edward H. Rosenthal, Denver, CO (US)

(21) Appl. No.: 12/684,939

(22) Filed: Jan. 9, 2010

(51) Int. Cl. B60S 13/00

(52) U.S. Cl. 414/258; 414/227

(57) ABSTRACT

Broadly, the present invention is a transport apparatus for manually moving a vehicle along a surface, the transport apparatus including a first planar extension having a first longitudinal axis and a second planar extension having a second longitudinal axis, wherein the first longitudinal axis and the second longitudinal axis are substantially parallel to one another and the first and second planar extensions are operational to support a vehicle. Further included in the transport apparatus a means for a bi-directional movement of the first and second planar extensions along the surface, wherein the movement is along a single axis oriented substantially perpendicular to the first and second longitudinal axes.

### TECHNICAL FIELD

The present invention relates generally to an apparatus for transporting an article across a surface. More specifically, the present invention relates to an apparatus for selectively moving a vehicle on a surface. The apparatus includes a platform structure that the vehicle can move up upon wherein the structure has a rolling element disposed upon the surface to facilitate vehicle positioning on the surface that is not easily attainable by the vehicle itself.

### BACKGROUND OF INVENTION

Vintage, classic, specialty, and collector vehicles which could be termed “unique or specialty vehicle” collecting is a popular avocation for many people who have that “special” vehicle or vehicles, wherein usually these special vehicles are in addition to a person's everyday vehicles that are typically driven daily in bad weather and so on. Many unique vehicle owners frequently drive these unique vehicles for the enjoyment of being on the road with their unique vehicle to maximize their driving pleasure and to show their unique vehicle to others. However, with limited garage space that is consumed with additional other unique vehicles, their everyday cars, and bicycles, motorcycles, yard, and garden equipment, and the like, garage space is usually at a premium, thus a transport apparatus that could function as a way to more efficiently use garage space would be welcome as a way to better accommodate all of the aforementioned garage items and especially the unique vehicle(s). Very frequently, these specialty vehicles are stored in a relatively small garage that is part of the vehicle owner's home.

More often than not, these specialty vehicles are rare and valuable, if not also delicate and difficult as well as expensive to repair. The owners of these specialty vehicles take great pride in maintaining the pristine condition of these vehicles and also often take extensive measures to protect the exterior of these specialty vehicles from mechanical damage caused by other vehicles, tools, bicycles, lawn mowers, and the like that are often found in a residential (or any) garage. In addition to protecting their specialty vehicles from damage while stored in the garage, as previously mentioned the owners of these vehicles often wish to drive their vehicles fairly frequently, which implies quick and easy access to the specialty vehicle into and out of the garage. The combination of the desire to protect the bodywork of these specialty vehicles from damage as well as the desire to drive these vehicles frequently creates the need for a transport apparatus that will possess at least the dual functions of:
1. Allowing rapid and frequent engagement and disengagement of the specialty vehicle from the transport apparatus, basically simply driving on and off of the apparatus without special tools and without the additional assistance or guidance of individuals other than the owner of the vehicle.
2. Allowing the specialty vehicle which is stored upon the transport apparatus to be easily manually pushed by the single individual owner to a safe location within the environment of the garage for temporary storage and then easily returned to its original position so that the specialty vehicle can be driven off the transport apparatus and out of the garage.

Thus the ability to drive onto the transport apparatus, get out of the specialty vehicle and easily push the vehicle/transport apparatus combination into a precise and repeatable position within the garage while also allowing easy reversal of this process with all movements performed by a single individual without additional tools would describe a desirable transport apparatus which will provide enhanced protection of the specialty vehicle while also providing convenient and frequent access to the specialty vehicle.

This simple, one-step process is in contrast to an owner/driver performing the following individual, time-consuming steps with a typical prior art apparatus in this area utilizing four separate caster-based wheel dollies that need to be individually placed under each specialty vehicle tire, with the use of the typical prior art apparatus requiring the following steps:
1. driving the specialty vehicle into the garage
2. exiting the vehicle
3. retrieving and (re)positioning the individual movable wheel dollies from within the garage to be placed in front each vehicle tire
4. jacking up each tire and positioning the individual movable wheel dollies under each tire
5. lowering each tire onto individual moveable wheel dollies
6. pushing the vehicle which is now positioned on the wheel dollies into the desired location within the garage (where precisely locating the vehicle within a confined space in the garage is often complicated by the omni-directionality of conventional wheel dollies and caster trail effects of the steerable tires of the vehicle turning inadvertently when the vehicle is pushed.)
7. reversing the entire process when the owner wishes to drive his/her specialty vehicle.

Even in the situation of a prior art drive-on individual wheel dollies with short ramps, it is difficult to have each individual specialty vehicle tire “grab on to” each individual short ramp section simultaneously, wherein what usually occurs is that one tire will “grab on” one of the short individual wheel dolly ramps and then the other tires will push the other individual wheel dolly ramps in front of the other tires without “grabbing on” i.e. going up the short ramp, as the other individual wheel dollies simply get bumped via rolling forward on the surface by the tire rolling forward. Further, in this type of prior art of individual drive on wheel dollies, there is a problem of the specialty vehicle exiting the individual short ramp dollies as the drive tire of the specialty vehicle could eject one of the short ramp wheel dollies out from under the drive tire, while leaving the other individual wheel dollies in their still under the tire position, with the only solution being to lock all of the caster wheels of the individual dollies to simulate the specialty vehicle driving off of static ramps without casters.

Thus to summarize, the desired transport apparatus would accommodate quite frequent cycles of being put on and off the transport apparatus, such that only one person, i.e. the driver is required to put the specialty vehicle onto the transport apparatus and to remove the specialty vehicle from the transport apparatus, such that a quick and easy drive on/drive off process upon the transport apparatus that is a single rigid assembly and not being individual wheel dollies, would allow multiple and frequent uses of the transport apparatus for the driver of the specialty vehicle. Thus the ability to drive onto the transport apparatus, exit the specialty vehicle and easily push the specialty vehicle into a precise and repeatable position, with the ability to easily reverse this process by the driver manually moving the specialty vehicle into its previous position repeatably while it is on the transport apparatus and simply driving the vehicle off of the transport apparatus and onto the road. This is as opposed to the typical prior art case of having to jack-up the vehicle tires (usually one at a time) with individually positioning of each independent tire movable wheel dolly support, frequently requiring more than one person to accomplish and considerably more time to get the specialty vehicle upon each individual tire movable wheel dolly support to maneuver the specialty vehicle into a usually one-time desired position in the garage, with the prior art omnidirectional wheel dollies being more for the long term restoration and garaging of the vehicle.

In returning to the challenge of positioning the specialty vehicle in the limited space garage, there is of course the option of manually moving the vehicle back and forth by steering, however, this option would be undesirable due to the effort and time involved, requiring a number of people to move and direct the vehicle. The result of this discussion is to point out the need for a way to easily (meaning only requiring a single individual using minimal effort) move the specialty vehicle that could weigh up to multiple tons around a garage floor that can accommodate confined spaces for moving the specialty vehicle, thus meaning that the back and forth movement with steering as previously described is undesirable, wherein this leads one to look toward the existing portable dolly arts, drawing design from furniture and appliance moving, wherein the need for moving heavy items in confined spaces is typically confronted, also in the machine and material handling arts, wherein a portable dolly could be utilized.

Yet further, an additional issue is of getting the heavy vehicle up upon the dolly, which of necessity the dolly must be suspended a certain distance above the floor surface to enable moving the dolly along the surface, ideally this getting the heavy specialty vehicle up upon the dolly should be a single individual job also, implicitly meaning that the dolly should be designed such that the suspension distance of the dolly above the floor surface must be minimized to accordingly minimize the energy required to place the specialty vehicle up on the dolly. Next, in going with the high weight of the vehicle safety must be of the upmost concerning for getting the vehicle up on the dolly, plus the positioning of the vehicle of the dolly, and controlling dolly movement along the garage floor surface, wherein the high vehicle weight intensifies the need for safety.

The prior art has recognized the importance and the need for the aforementioned type of dolly, and there have been a number of different approaches to addressing the issues previously pointed out that include, ease of placing a heavy vehicle upon the dolly, positioning the vehicle to the dolly, and the substantially unmet need for control of moving the dolly/vehicle combination in a safe and controlled manner along the garage floor surface.

In the dolly prior art with U.S. Pat. No. 5,049,025 to Roman, disclosed is an automobile dolly capable of engaging both front or both rear tires of an automobile conveniently, reference Column 1, lines 51-53. The dolly in Roman comprises a first, U-shaped part having casters and a first side element for engaging the front sides of the tires of an automobile. A second side element in Roman is attached to the first part after the first part is in place to engage the rear sides of the tires. Two threaded rods in Roman are attached to the first and second parts, and a nut is applied to each of the rods, when the nuts are rotated, such as by a wrench, the two parts are pulled together, and the two tires are raised. In Roman the same process is preferably followed for the other end of the automobile whereby both ends are placed on dollies, thus one vehicle axle equals one dolly assembly in Roman.

Thus, the automobile may be moved around the workshop by virtue of a plurality of caster wheels, much like a supermarket cart front caster wheel in multiple, reference column 1, lines 58-68, and column 2, lines 1-2. Note that in Roman, a problem will occur in the caster wheel having to pivot about its axis of rotation, requiring a scrubbing of the wheel outside diameter as against the garage floor surface, meaning that a dynamic contact patch is required as between the wheel outside diameter and the garage floor surface, as this is normally not a significant issue for a grocery cart caster wheel as being against a very smooth floor surface with a relatively light weight placed upon it. However, with the much higher weight of a vehicle and with the relatively courser surface of a garage floor, the caster wheel will have a high pivoting movement resistance, resulting on the force required to move the vehicle using the Roman dolly in a new direction will be undesirably high, going against the previously stated goal of easy single individual movement of the dolly across the garage floor with the weight of the vehicle on the dolly.

Continuing in the dolly prior art, in U.S. Pat. No. 5,732,960 to Elam disclosed is a wheel dolly that can silently raise an automobile wheel assembly from the ground surface to transport height in seconds and with minimal effort expended by a user via the use of mechanical advantage through a lever pivoting the caster wheel upward in a pivoted up state once the vehicle wheel is positioned in place in the dolly. The wheel dolly in Elam having an ultra-low profile capable of being readily positioned beneath the bodies of sports cars and other land vehicles for use in a pivoted down state, reference column 1, lines 52-60. The wheel dolly in Elam features a generally U-shaped frame including a base member and a pair of spaced arm assemblies includes a load-bearing arm extending at substantially right angles from the base member and a torsion arm secured to the load-bearing arm.

A pry bar in Elam is removably attached to the torsion arm for pivoting the load-bearing arm, which engages the wheel assembly of an automobile, to lift and transport the automobile. Secured to each of the load-bearing arms in Elam are caster wheel sets to facilitate pivoting of the load-bearing arm and to provide for movement of the dolly over the ground surface. The dolly in Elam also features unique latching mechanisms secured to the base member to selectively secure the arm assemblies in a fixed position in which the automobile is lifted from the ground surface and the caster wheels are in rolling engagement with the ground surface, reference Column 2, lines 4-21. Note that in Elam, as previously discussed in Roman, the supermarket style caster wheels are not suitable for easy single individual movement of the vehicle laden dolly across the garage floor.

Further in the dolly prior art area, in U.S. Pat. No. 6,860,496 to Novak, et al. disclosed is a dolly system for moving vehicles or more specifically large printer paper rolls 900, in any desired location, being most similar to Elam in design. In Novak et al., at least three dollies can be adjustably interconnected as a system to allow a trailer or other vehicle to be loaded thereon. The dollies in Novak et al., are adjusted for the width and the length of the trailer to align the dollies with the wheels of the trailer and four dollies can be adjustably connected in a system to provide a four-wheel vehicle dolly system. The dollies in Novak et al., can be identical to one another, further the system can include one or more brakes and once loaded the system can be moved to facilitate the maximum use of available parking space, reference column 2, lines 14-28. Note the same issue in Novak et al., i.e. the same caster wheel issue as in Elam and Roman with a heavy vehicle weight placed upon the caster wheel on a course garage floor surface, further with Novak et al., only having the front wheels caster and the rear wheels in a fixed rotational axis would have great difficulty in turning the dolly with the vehicle wheels remaining in their typical fixed position, also note that another application in Novak, et al. for paper roll 900 moving, would be acceptable as the paper roll is free to independently move omni-directionally which would accommodate the fixed rotational axis/caster wheel rear front combination, this as opposed to a four wheeled vehicle wherein the four wheels are fixed in position to each other.

Next, in the prior art for the dolly arts looking in U.S. Pat. No. 7,097,406 to Gang disclosed is a wheel skate having an adjustable frame which is adapted to be fitted to the wheel assembly of a motor vehicle being similar to Elam. The frame assembly in Gang is connected to a foot pedal lever that is operable to contract a telescopically connected first and second frame members of the frame assembly and position a pair of arms having a plurality of rollers in engagement with opposite sides of the tire to raise the vehicle wheel assembly off the ground surface. A plurality of caster wheel assemblies in Gang supports the frame assembly on the ground surface and provides the desired mobility of the wheel skate.

Also, as in Elam and Roman the previously discussed problems of excessive caster wheel pivotal surface friction from the high vehicle weight will make moving the vehicle across the garage floor require excessive force, which is not desirable for single user operation. In Gang a locking member extends through holes in the frame members to lock the position of the frame assembly. Further in Gang, when the lever is operated to contract the frame assembly, the locking member is forced upwardly to allow the contraction, reference Column 1, lines 54-67. Upon completion of the contraction movement in Gang, the locking member is moved downwardly through a following hole in the second frame member to relock the position of the frame assembly thereby preventing inadvertent separation of the frame members, reference Column 2, lines 1-5.

What is needed is a transport apparatus that is adaptable to being functional in accommodating the three desirable goals in a transport apparatus for a vehicle that is operable in a confined space floor wise. These three goals include ease of placing a heavy vehicle upon the dolly, ease of positioning the vehicle upon the dolly, and ease of control of moving the dolly/vehicle combination in a safe and controlled manner along the garage floor surface, all preferably accomplished by a single individual expending minimal time and effort for the upmost convenience thereby confirming the ease of use of the transport apparatus.

Thus in accordance with the goals stated above, the key issues for the transport apparatus are to minimize the distance above the floor surface for the dolly, thus minimizing the energy required to move the vehicle up on the dolly, further positioning the vehicle to the dolly with the least amount of effort, and not having caster wheels as a means for movement along the garage floor surface due to the high maneuverability resistance and difficulty of control, plus rolling control for safety to prevent a run-away vehicle as it is moving along the garage floor surface, which could be very dangerous due to the vehicles weight, that was not addressed in any of the cited prior art. Further, another desirable feature is to have the alignment of the dolly wheels be inherently controlled by the transport apparatus structure itself, thus the dolly wheel alignment is independent of the vehicle structure making for consistent dolly wheel positioning leading to minimal rolling friction on the surface and repeatable positioning on the transport apparatus movement.

### SUMMARY OF INVENTION

Broadly, the present invention is a transport apparatus for manually moving a vehicle along a surface, the transport apparatus including a first planar extension having a first longitudinal axis and a second planar extension having a second longitudinal axis, wherein the first longitudinal axis and the second longitudinal axis are substantially parallel to one another and the first and second planar extensions are operational to support a vehicle. Further included in the transport apparatus a means for a bi-directional movement of the first and second planar extensions along the surface, wherein the movement is along a single axis oriented substantially perpendicular to the first and second longitudinal axes.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a perspective view of the transport apparatus with the first planar extension and the second planar extension including the means for bi-directional movement with the nested cantilever platforms in their angled state all upon the surface;

FIG. 2 shows a perspective view of an alternative embodiment of the transport apparatus with the planar extension including the means for bi-directional movement with the nested cantilever platform in its angled state all upon the surface;

FIG. 3 shows a side elevation cross sectional view 3-3 of both FIGS. 1 and 2 of the of the transport apparatus which could be either the planar extension from section 3-3 of FIG. 2, the first planar extension from section 3-3 of FIG. 1, or the second planar extension from section 3-3 of FIG. 1, with the nested cantilever platform in its angled state all upon the surface, further shown is the nominal distance as between the planar extension, first planar extension, or second planar extension and the surface;

FIG. 4 shows a side elevation cross sectional view 3-3 of both FIGS. 1 and 2 of the of the transport apparatus which could be either the planar extension from section 3-3 of FIG. 2, the first planar extension from section 3-3 of FIG. 1, or the second planar extension from section 3-3 of FIG. 1, with the nested cantilever platform removed to show with clarity the finger, wherein the pivotal attachment is disposed therein;

FIG. 5 shows an end elevation view of the transport apparatus that is oppositely disposed from the nested cantilever platform showing the first planar extension and the second planar extension including the means for bi-directional movement all upon the surface, further shown is the nominal distance as between the first planar extension and the second planar extension and the surface;

FIG. 6 shows a side elevation view of the of the transport apparatus which could be either the planar extension, first planar extension, or second planar extension, with the nested cantilever platform in its angled state all upon the surface, further shown is the nominal distance as between the planar extension, first planar extension, or second planar extension and the surface;

FIG. 7 shows a perspective use view of the planar extension, first planar extension, or second planar extension in looking at the nested cantilever platform in particular that is in the linear operational state with the vehicle positioned upon the opposing arm portion of the nested cantilever platform with the shoe portion of the nested cantilever platform pivoted away from the surface via the pivotal attachment at the finger thus allowing the bi-directional movement to occur;

FIG. 8 shows a perspective use view of the planar extension, first planar extension, or second planar extension in looking at the nested cantilever platform in particular that is in the angled operational state with the vehicle not present upon the opposing arm portion of the nested cantilever platform with the shoe portion of the nested cantilever platform pivoted toward and in contact with the surface via the pivotal attachment at the finger thus allowing the vehicle to enter from the surface to either the planar extension, first planar extension, or second planar extension;

FIG. 9 shows a side elevation use view of the planar extension, first planar extension, or second planar extension in looking at the nested cantilever platform in particular that is in the linear operational state with the vehicle positioned upon the opposing arm portion of the nested cantilever platform with the shoe portion of the nested cantilever platform pivoted away from the surface via the pivotal attachment thus allowing the bi-directional movement to occur, also shown is the position of the vehicle contact support being in-between the fixed rotational axis and the surface to minimize the nominal distance;

FIG. 10 shows a perspective view of the planar extension, first planar extension, or second planar extension as viewed from the surface to more clearly show the means for bi-directional movement;

FIG. 11 is a perspective view of the means for automatic conditional substantial restriction of the bi-directional movement of the transport apparatus showing the control that includes the beam, the distal end portion of the beam, the opposing proximal end portion of the beam, and the optional means for biasing the proximal end portion toward the surface, in particular with the means for automatic conditional substantial restriction of the bi-directional movement having the beam in the substantially locked state wherein the proximal end portion is contacting the surface;

FIG. 12 is a perspective view of the means for automatic conditional substantial restriction of the bi-directional movement of the transport apparatus showing the control that includes the beam, the distal end portion of the beam, the opposing proximal end portion of the beam, and the optional means for biasing the proximal end portion toward the surface, in particular with the means for automatic conditional substantial restriction of the bi-directional movement in the substantially unlocked state wherein the proximal end portion is manually moved away from contacting the surface resulting in the means for automatic conditional substantial restriction of the bi-directional movement having the beam in the substantially unlocked state; and

FIG. 13 shows a perspective use view of the transport apparatus with the vehicle in position to have the user engage in manual force to effect bi-directional movement to move the vehicle across the surface placing the transport apparatus into the moving state.

### REFERENCE NUMBERS IN DRAWINGS

30 Transport apparatus
35 Vehicle or article
36 Position of the vehicle 35
40 Surface
45 Manually moving the vehicle 35 across the surface 40
46 Planar extension
47 Longitudinal axis of planar extension 46
50 First planar extension
55 First longitudinal axis of the first planar extension 50
60 Second planar extension
65 Second longitudinal axis of the second planar extension 60
66 Finger of the planar extension 46, first planar extension 50 or the second planar extension 60
70 Substantially parallel positioning of the planar extension 46, first planar extension 50 and the second planar extension 60
71 Transverse member
72 Clearance for pivotal movement at pivotal attachment 150 to facilitate the angled state
155 of the nested cantilever platform 135
75 Bi-directional movement
76 Manual force to effectuate the bi-directional movement 75
80 Means for bi-directional movement 75 of the planar extension 46, the first 50, and the second 60 planar extensions along the surface 40
81 Axis of movement 75
85 Single axis 81 of bi-directional movement 75 that is oriented substantially perpendicular to the longitudinal axis 47, the first 55 and the second 65 longitudinal axes
90 Plurality of rotational elements
91 Outer periphery of the rotational element 90
92 Width of the rotational element 90
95 Fixed rotational axis of each of the plurality of rotational elements 90
96 Parallel position of the width 92 to the rotational axis 95
100 Substantially parallel orientation of each of the fixed rotational axes 95
101 Co-axial alignment of the rotational axes 95 independent of the vehicle 35 position 36
105 Vehicle 35 being supported positionally in-between the plurality of fixed rotational axes 95 and the surface 40
110 Plurality of yokes
115 Axle that is co-axial to each fixed rotational axis 95
120 Projected axis that is substantially perpendicular to the surface 40
125 Two simultaneous directions of the projected axis 120
130 Equal projecting distance of each rotational element 90 beyond the planar extension 46, the first 50, and the second 60 planar extensions in the projected axis 120 in two simultaneous directions 125
135 Nested cantilever platform
140 Shoe portion of the nested cantilever platform 135
145 Opposing arm portion of the nested cantilever platform 135
150 Pivotal attachment of the nested cantilever platform 135
155 Angled state of the nested cantilever platform 135 upon the surface 40
160 Easing the vehicle 35 upon the planar extension 46, the first 50, and the second 60 planar extensions
165 Linear state of the nested cantilever platform 135
170 Parallel position of the nested cantilever platform 135 to the planar extension 46, the first 50, and the second 60 planar extensions
175 Contact of the vehicle 35 upon the arm 145
180 Lifting the shoe 140 from the surface 40
181 User
185 Means for automatic conditional substantial restriction of the bi-directional movement 75
190 Control for means 185
195 Moving state of the transport apparatus 30
200 Substantially static state of the transport apparatus 30
205 Beam of the control 190
210 Distal end portion of the beam 205
211 Grasping portion sized and configured for the user 181 of the distal end portion 210
212 Manual motion away from surface 40 of distal end portion 210
215 Opposing proximal end portion of the beam 205
216 Sizing and configuration of the proximal end portion 215 to contact the surface 40
217 Leg of the planar extension 46, the first planar extension 50, or the second planar extension 60, for the pivotal attachment 225
220 Pivotal portion of the beam 205
225 Pivotal attachment of the pivotal portion 220
230 Increasing of distance between the planar extension 46, or the first 50, or the second
60 planar extensions all in relation to the surface 40
231 Nominal distance between the planar extension 46, the first planar extension 50, and the second planar extension 60, all related to the surface 40
235 Decreasing of the distance between the planar extension 46, or the first planar extension 50, or the second planar extension 60 to the surface 40 a lesser amount than the increasing of distance 230
240 Substantially locked state of the beam 205
241 Substantially unlocked state of the beam 205
245 Means for biasing the proximal end portion 215 to contact the surface 40
250 Proximal end portion 215 contacting the surface 40
255 Manual motion of the distal end portion 210 toward the surface 40
260 Proximal end portion 215 not contacting the surface 40

### DETAILED DESCRIPTION

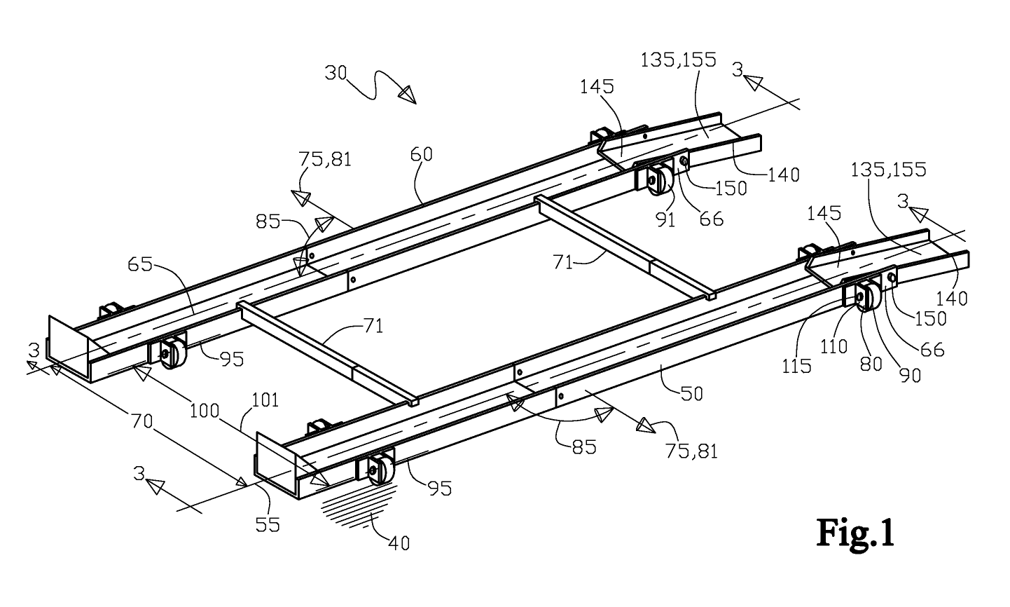

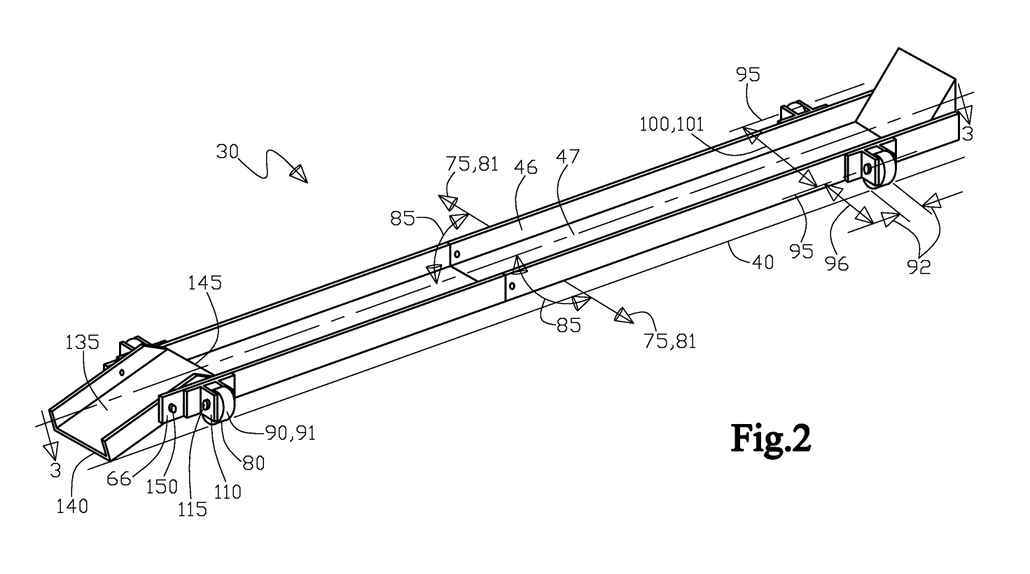

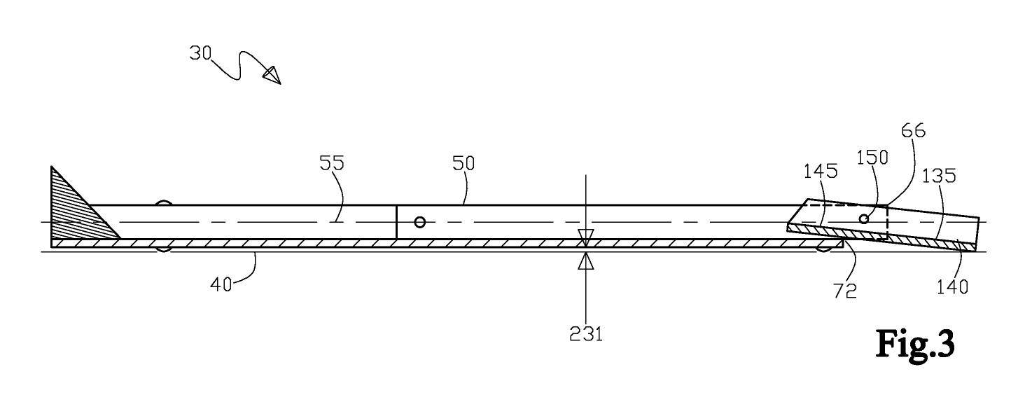

With initial reference to FIG. 1 shown is a perspective view of the transport apparatus 30 with the first planar extension 50 and the second planar extension 60 including the means 80 for bi-directional movement 75 with the nested cantilever platforms 135 in their angled state 155 all upon the surface 40. Continuing, FIG. 2 shows a perspective view of an alternative embodiment of the transport apparatus 30 with the planar extension 46 including the means 80 for bi-directional movement 75 with the nested cantilever platform 135 in its angled state 155 all upon the surface 40. Next, FIG. 3 shows a side elevation cross sectional view 3-3 of both FIGS. 1 and 2 of the of the transport apparatus 30 which could be either the planar extension 46 from section 3-3 of FIG. 2, the first planar extension 50 from section 3-3 of FIG. 1, or the second planar extension 60 from section 3-3 of FIG. 1, with the nested cantilever platform 135 in its angled state 155 all upon the surface 40, further shown is the nominal distance 231 as between the planar extension 46, first planar extension 50, or second planar extension 60 and the surface 40.

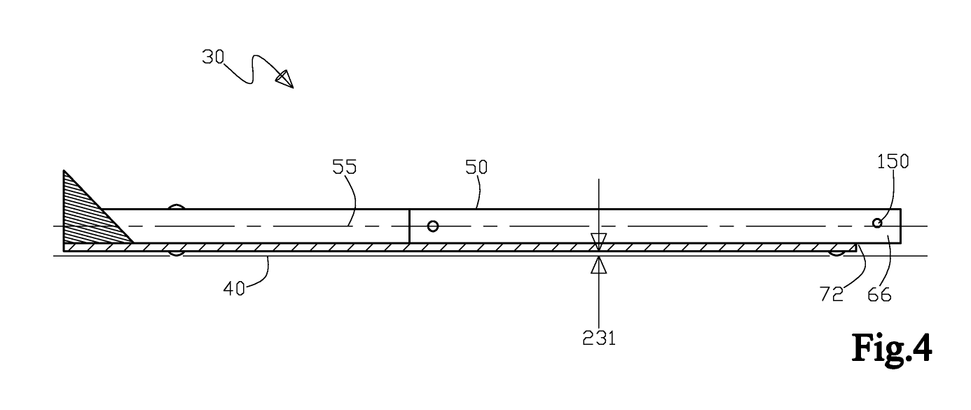

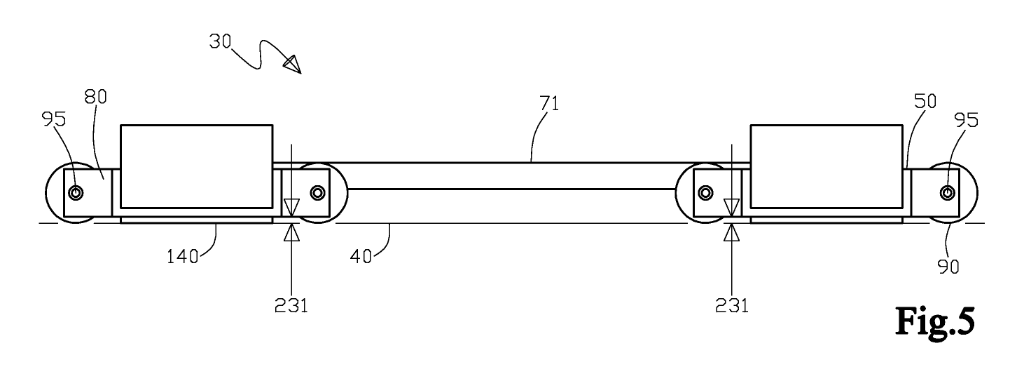

Moving onward, FIG. 4 shows a side elevation cross sectional view 3-3 of both FIGS. 1 and 2 of the of the transport apparatus which could be either the planar extension 46 from section 3-3 of FIG. 2, the first planar extension 50 from section 3-3 of FIG. 1, or the second planar extension 60 from section 3-3 of FIG. 1, with the nested cantilever platform 135 removed to show with clarity the finger 66, wherein the pivotal attachment 150 is disposed therein. Further, FIG. 5 shows a side elevation view of the transport apparatus 30 that is oppositely disposed from the nested cantilever platform 135 showing the first planar extension 50 and the second planar extension 60 including the means 80 for bi-directional movement 75 all upon the surface 40, further shown is the nominal distance 231 as between the first planar extension 50 and the second planar extension 60 and the surface 40.

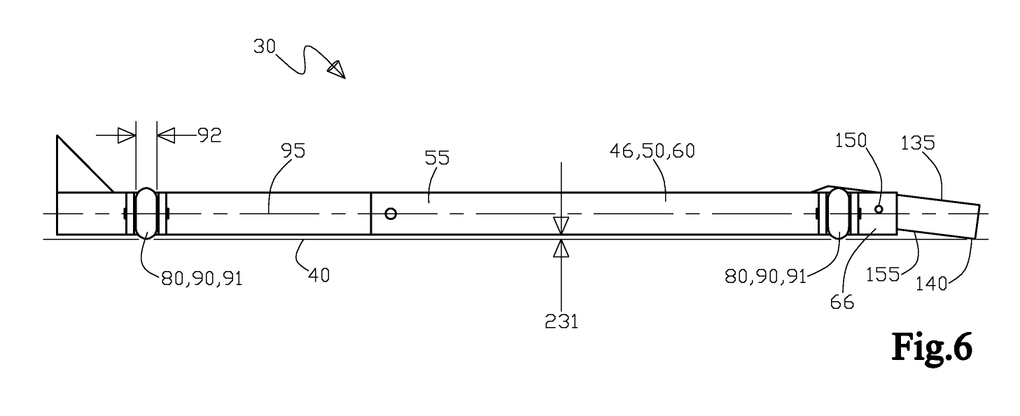

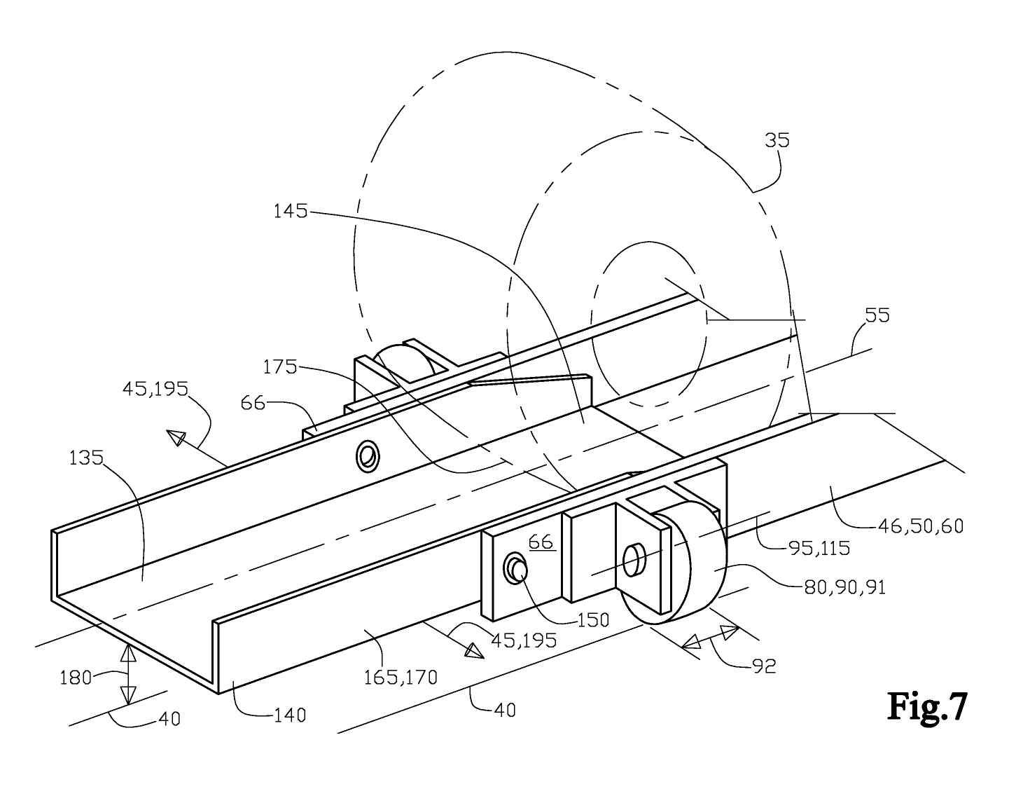

Yet further, FIG. 6 shows a side elevation view of the of the transport apparatus 30 which could be either the planar extension 46, first planar extension 50, or second planar extension 60, with the nested cantilever platform 135 in its angled state 155 all upon the surface 40, further shown is the nominal distance 231 as between the planar extension 46, first planar extension 50, or second planar extension 60 and the surface 40. Next, FIG. 7 shows a perspective use view of the planar extension 46, first planar extension 50, or second planar extension 60 in looking at the nested cantilever platform 135 in particular that is in the linear operational state 165 with the vehicle 35 positioned upon the opposing arm portion 145 of the nested cantilever platform 135 with the shoe portion 140 of the nested cantilever platform 135 pivoted away from the surface 40 via the pivotal attachment 150 at the finger 66 thus allowing the bi-directional movement 75 to occur.

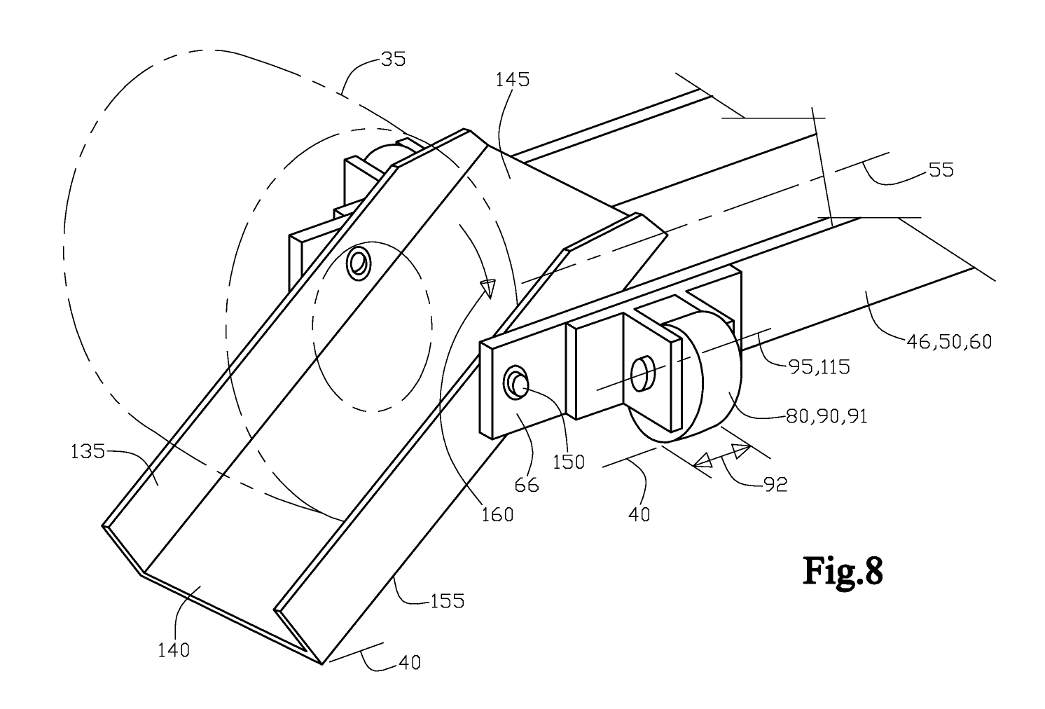

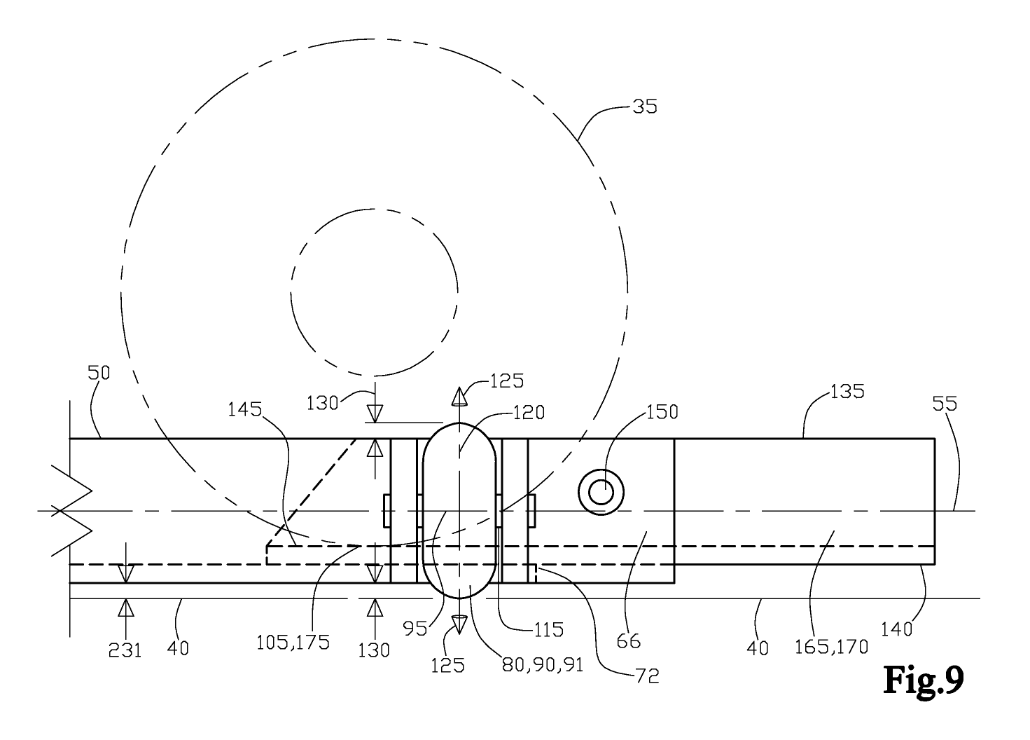

Continuing, FIG. 8 shows a perspective use view of the planar extension 46, first planar extension 50, or second planar extension 60 in looking at the nested cantilever platform 135 in particular that is in the angled operational state 155 with the vehicle 35 not present upon the opposing arm portion 145 of the nested cantilever platform 135. Further in FIG. 8 with the shoe portion 140 of the nested cantilever platform 135 pivoted toward and in contact with the surface 40 via the pivotal attachment 150 at the finger 66 thus allowing the vehicle 35 to enter 160 from the surface 40 to the planar extension 46, first planar extension 50, or second planar extension 60. Further, FIG. 9 shows a side elevation use view of the planar extension 46, first planar extension 50, or second planar extension 60 in looking at the nested cantilever platform 135 in particular that is in the linear operational state 165 with the vehicle 35 positioned upon the opposing arm portion 145 of the nested cantilever platform 135 with the shoe portion 140 of the nested cantilever platform 135 pivoted away from the surface 40 via the pivotal attachment 160 at the finger 66 thus allowing the bi-directional movement 75 to occur, also shown is the position of the vehicle 35 contact support 175 being in-between the fixed rotational axis 95 and the surface 40 to minimize the nominal distance 231.

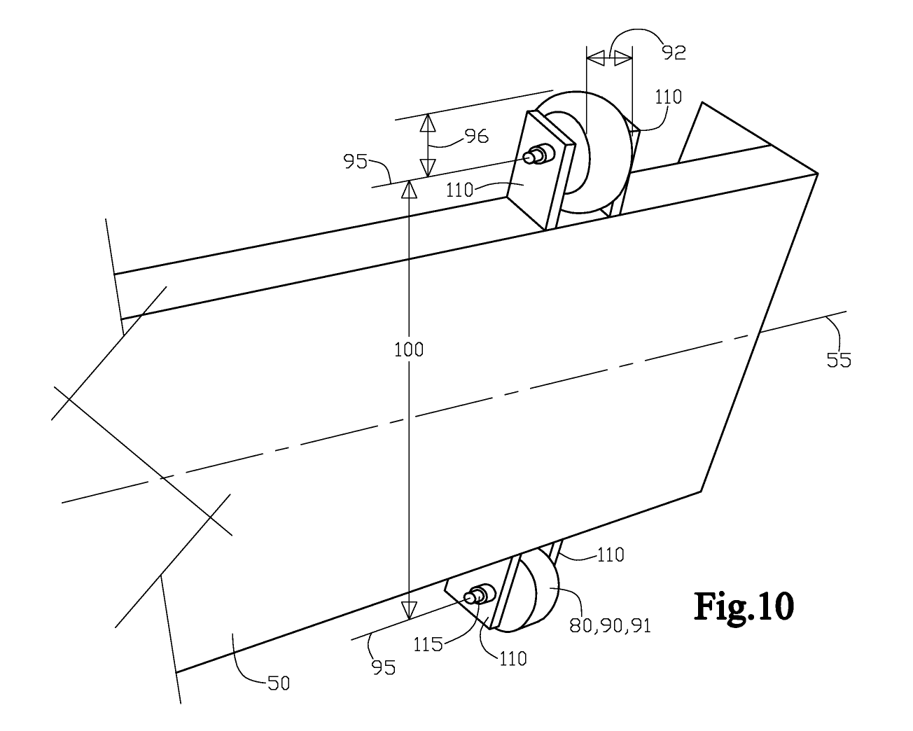

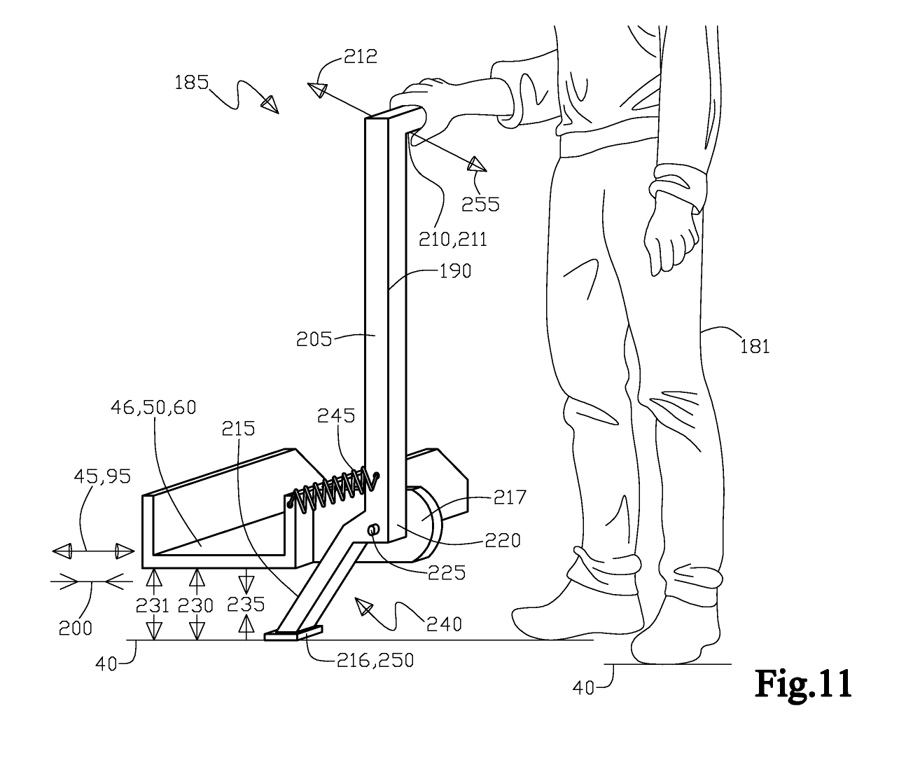

Next, FIG. 10 shows a perspective view of the planar extension 46, first planar extension 50, or second planar extension 60 as viewed from the surface 40 to more clearly show the means 80 for bi-directional movement 75. Further, FIG. 11 is a perspective view of the means 185 for automatic conditional substantial restriction of the bi-directional movement 75 of the transport apparatus 30 showing the control 190 that includes the beam 205, the distal end portion 210 of the beam 205, the opposing proximal end portion 215 of the beam 205, and the optional means 245 for biasing the proximal end portion 215 toward the surface 40, in particular with the means 185 for automatic conditional substantial restriction of the bi-directional movement 75 having the beam 205 in the substantially locked state 240 wherein the proximal end portion 215 is contacting the surface 40.

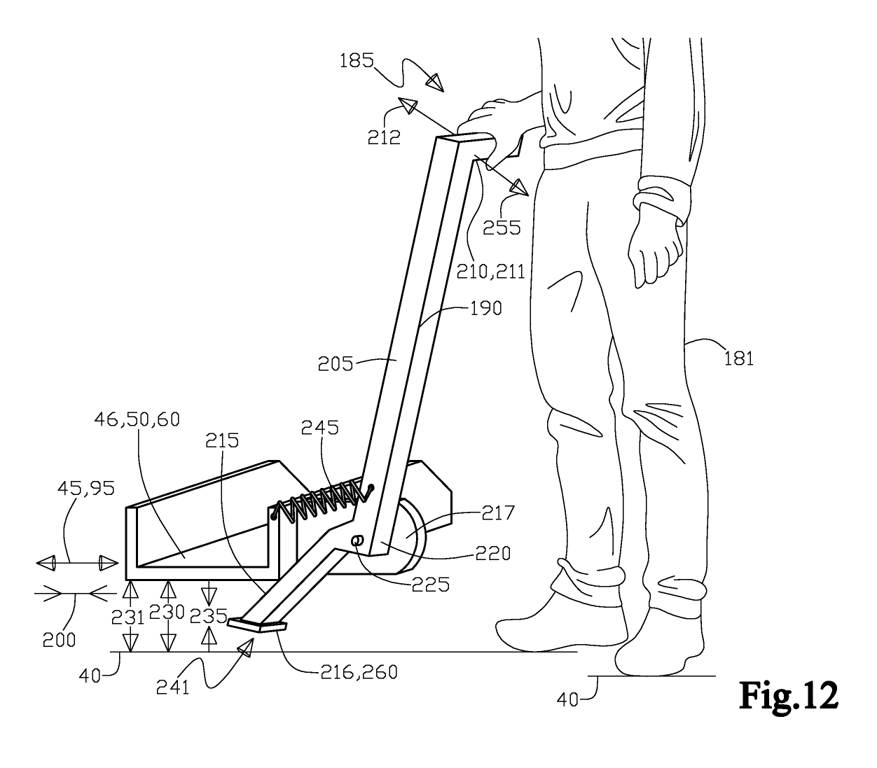

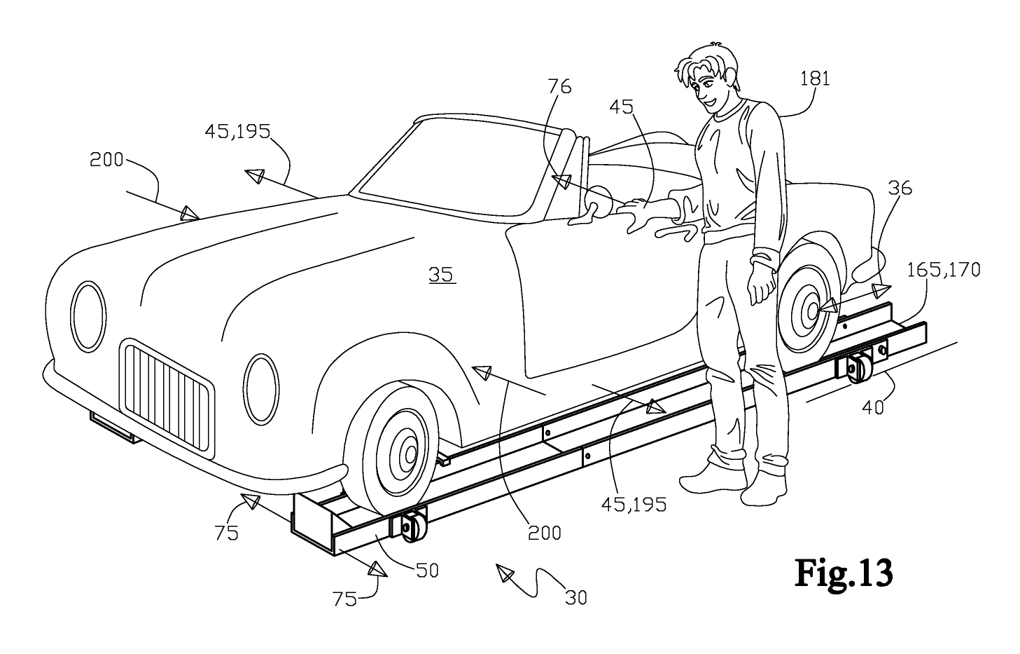

Continuing, FIG. 12 is a perspective view of the means 185 for automatic conditional substantial restriction of the bi-directional movement 75 of the transport apparatus 30 showing the control 190 that includes the beam 205, the distal end portion 210 of the beam 205, the opposing proximal end portion 215 of the beam 205, and the optional means 245 for biasing the proximal end portion 215 toward the surface 40. Further in FIG. 12, in particular with the means 185 for automatic conditional substantial restriction of the bi-directional movement 75 in the substantially unlocked state 241 wherein the proximal end portion 215 is manually moved 212 away from contacting the surface 40 resulting in the means 185 for automatic conditional substantial restriction of the bi-directional movement 75 having the beam 205 in the substantially unlocked state 241. Moving ahead, FIG. 13 shows a perspective use view of the transport apparatus 30 with the vehicle 35 in position to have the user 181 engage in manual force 76 to effect bi-directional movement 75 to move 45 the vehicle 35 across the surface 40 placing the transport apparatus 30 into the moving state 195.

Broadly the present invention, as best shown in FIGS. 1 through 12, is a transport apparatus 30 for manually moving 45 a vehicle 35 along a surface 40, the transport apparatus 30 including a first planar extension 50 having a first longitudinal axis 55 and a second planar extension 60 having a second longitudinal axis 65, wherein the first longitudinal axis 55 and the second longitudinal axis 65 are substantially parallel 70 to one another, as best shown in FIG. 1, and the first 50 and second 60 planar extensions are operational to support a vehicle 35, as best shown in FIG. 13. Further included in the transport apparatus 30 a means 80 for a bi-directional movement 75 of the first 50 and second 60 planar extensions along the surface 40, wherein the movement 75 is along a single axis 81 oriented substantially perpendicular 85 to the first 55 and second 65 longitudinal axes, as best shown in FIG. 1. As the first 50 and second 60 planar extensions of the transport apparatus 30 are shown in FIG. 1 and with the vehicle 35 in FIG. 13, an alternative embodiment as shown in FIG. 2, with a single planar extension 46 could be utilized for a motor cycle, scooter, or larger heaver bicycle, further the vehicle 35 can include an article 35 such as furniture, appliances, and the like that could require movement 45 across the surface 40, wherein the means 80 for bi-directional movement 75, the nested cantilever platform 135, and the means 185 for automatic conditional substantial restriction of the bi-directional movement 75, all apply as described to both the embodiment of the first 50 and second 60 planar extensions of the transport apparatus 30 as shown in FIG. 1 and the planar extension 46 of the transport apparatus 30 as shown in FIG. 2.

Further, on the means 80 for bi-directional movement 75 of the transport apparatus 30 for manually moving 45 a vehicle 35 along a surface 40, wherein the means 80 for bi-directional movement 75 includes a plurality of rotational elements 90, wherein each rotational element 90 has a fixed rotational axis 95 sized and configured in relation to the first 50 and second 60 planar extensions, such that each fixed rotational axis 95 is oriented substantially parallel 100 to the first 55 and second 65 longitudinal axes and the vehicle 35, as best shown in FIGS. 1 and 10. Wherein the vehicle 35 is supported positionally 105 in-between the plurality of fixed rotational axes 95 and the surface 40, as best shown in FIG. 9, wherein operationally the plurality of rotational elements 90 facilitate the bi-directional movement 75, as shown in FIGS. 1 and 13.

Continuing, on the means 80 for bi-directional movement 75 of the transport apparatus 30 for manually moving 45 a vehicle 35 along a surface 40, the means 80 for bi-directional movement 75 further includes a plurality of yokes 110 that are attached to the first 50 and second 60 planar extensions as best shown in FIGS. 1, 5, 7, 8, and 10. Wherein each yoke 110 preferably straddles each rotational element 90 such that each yoke 110 supports an axle 115 that is co-axial to each fixed rotational axis 95, wherein a position of each fixed rotational axis 95 is such that each rotational element 90 extends an equal projecting distance 130 beyond the first 50 and second 60 planar extensions in a projected axis 120 substantially perpendicular to the surface 40 in two simultaneous opposing directions 125 as best shown in FIG. 9. Note that the yokes 110 could optionally be on only one side of each rotational element 90 as opposed to straddling as described above.

Further, on the rotating element 90 for the transport apparatus 30 for manually moving 45 a vehicle 35 along a surface 40, wherein each the rotating element 90 has an outer periphery 91 that is at least six (6) times a width 92 of each rolling element 90, with the width 92 being parallel 96 to the rotational axis 95, as best shown in FIGS. 7, 8, and 10. Wherein, for example the outer periphery 91 is preferably determined by using a three inch diameter rotating element 90 multiplied by pi being 3.14 equals 9.42 inches for the outer periphery 91 which is divided by the preferred rotating element 90 width 92 of one and three-eighths inches which equals a ratio of 6.8 for the preferred embodiment. For any alternative embodiments the outer periphery 91 to width 92 ratio would increase, typically via the outer periphery 91 increasing which would provide for a lower rolling movement 75 surface 40 friction due to a smaller contact patch of the periphery 91 with the surface 40.

Which brings up one of the benefits of the present invention, in that due to the non-caster (i.e. no pivotal axis that is perpendicular to the surface, thus in other words the rotating elements 90 are not steerable) nature of the rotating element 90, the diameter or outer periphery 91 of the rotating element has the ability to increase while not requiring the support nominal distance 231 to not have to increase, see FIG. 9. Wherein it is desirable to minimize nominal distance 231 for safety, with dimension distance 231 being preferably about five-eighths of an inch, again see FIG. 9, i.e. the potential falling distance of the vehicle 35 to the surface 40 is minimal, also a smaller distance 231 makes for easier placing 160, see FIGS. 7 and 8, of the vehicle upon and off of the planar extension 46, or the first planar extension 50 and the second planar extension 60, further, the non caster nature of the rotating elements 90 makes for a safer and more controllable movement of the vehicle 35, see FIG. 13, while upon the transport apparatus 30 by allowing only bi-directional movement 75. This is as opposed to omni-directional movement with caster type wheels, with the option for even increased safety by including the means 185 for automatic conditional substantial restriction of bi-directional movement 75, see FIGS. 11 and 12.

Further, for the rotating element 90 on the transport apparatus 30 for manually moving 45 a vehicle along a surface 40 wherein the plurality of rotational axes 95 are sized and configured to stay in co-axial alignment 101 independent of the vehicle 35 position in relation to the planar extension 46, the first planar extension 50, or the second planar extension 60, see FIGS. 1, 2, 7, 8, and 13, being operational to minimize a manual force 76 required to effectuate the bi-directional movement 75 by the user 181, as shown in FIG. 13, as the rotational elements 90 all remain in alignment to one another for minimal friction on movement 75 on the surface 40, not dependent upon vehicle 35 position.

Continuing, as an option for the transport apparatus 30 for manually moving 76 a vehicle 35 along a surface 40 can further comprise a nested cantilever platform 135 for each of the planar extension 46, the first planar extension 50, or the second planar extension 60, wherein each platform extension 46 is pivotally attached 150 to finger 66 of each of the planar extension 46, the first planar extension 50, or the second planar extension 60, wherein each platform extension 46 includes a shoe portion 140 and an opposing arm portion 145 with the pivotal attachment 150 positioned therebetween on finger 66, as best shown in FIGS. 7 and 8. Each nested cantilever platform 135 is operational to ease 160 the vehicle 35 upon the planar extension 46, the first planar extension 50, or the second planar extension 60 utilizing the shoe portion 140 in an angled state 155 upon the surface 40, see FIG. 8.

Wherein when the vehicle 35 is fully upon the planar extension 46, in position 36 the first planar extension 50, or the second planar extension 60, the vehicle 35 contacts 175 the arm portion 145, see FIGS. 7 and 9, thus to move or lift 180 the shoe portion 140 from the angled state 155 to a linear state 165 being parallel 170 to the planar extension 46, the first planar extension 50, or the second planar extension 60, thus lifting 180 the shoe 140 from the surface 40 to facilitate the bi-directional movement 75, as best shown in FIG. 13. Note that in particular as shown in FIGS. 3, 4, 6, 7, 8, and 9, the finger 66 wherein the pivotal attachment 150 is disposed further has a clearance 72 that facilitates the shoe portion 140 of the nested cantilever platform 135 to achieve the angled state 155, as best shown in FIGS. 3, 4, 6, and 8, and in particular FIG. 8, wherein the angled state 155 is shown in an exaggerated position for clarity. As the current nested cantilever platform 135 is more that a basic on/off ramp, because the platform 135 achieves two operational states, being the default angled state 155 which allows for the vehicle 35 to ease 160 up upon the platform 135, in FIG. 8, utilizing the finger 66 and clearance 72, then subsequently with the vehicle 35 bringing the platform 135 into the linear state 165 from the vehicle resting upon the arm portion 145, as best shown in FIGS. 7, 9, and 13.

Further, as another option for the transport apparatus 30 for manually moving 76 a vehicle 35 along a surface 40 can further comprise a means 185 for automatic conditional substantial restriction of the bi-directional movement 75, as particularly shown in FIGS. 11 and 12. Continuing on the means 185 for automatic conditional substantial restriction of the bi-directional movement 75 of the transport apparatus 30 for manually 76 moving a vehicle 35 along a surface 40, the means 185 for automatic conditional substantial restriction of the bi-directional movement 75 is a control 190. The control 190 is adjacent to the planar extension 46, the first planar extension 50, or the second planar extension 60, that must have a grasp 211 by a user 181 for the bi-directional movement 75 to occur in a moving state 195 of the transport apparatus 30, see FIGS. 12 and 13. Wherein, the user 181 releasing the grasp 211 of the control 190 results in a substantial restriction of the bi-directional movement 75 from occurring in a substantially static state 200 of the transport apparatus 30, see FIGS. 11 and 13.

Further, in returning to FIGS. 11 and 12 in particular, on the control 190 for the transport apparatus 30 for manually moving 45 the vehicle 35 along the surface 40 wherein the control 190 is formed from a beam 205 including a distal end portion 210, an opposing proximal end portion 215, and a pivotal portion 220 positioned therebetween. Wherein the pivotal portion 220 is pivotally attached 225 via a leg 217 to the planar extension 46, the first planar extension 50, or the second planar extension 60, wherein the pivotal attachment 225 is preferably about one and one-half inches from the surface 40. The distal end portion 210 is adapted to be grasped 211 by the user 181, with the proximal end portion 215 is sized and configured 216 to contact the surface 40 via a resilient tip end or any other higher friction surface treatment for contacting the surface 40, as best seen in particular in FIG. 11. Alternatively, again in looking in particular at FIG. 11, when the distal end portion 210 is grasped 211 in a motion away 212 from the surface 40, wherein a nominal distance 231 between the planar extension 46, the first planar extension 50, or the second planar extension 60, and the surface 40 is first increased 230 and then decreased 235 a lesser amount to manually urge the beam 205 into a substantially locked state 240 ceasing the motion 75 equating to the static state 200 of the transport apparatus 30, as shown in FIG. 11. Wherein the increasing 230 and then lesser decreasing 235 of the nominal distance 231 equates to a “toggle” effect for locking the beam 205 proximal end portion as against the surface 40 thus preventing the transport apparatus 30 from the bi-directional movement 75 being in the static state 200.

Alternatively, in again looking at FIGS. 11 and 12, for an alternative embodiment on the control 190 for the transport apparatus 30 for manually moving 45 the vehicle 35 along the surface 40 wherein the control 190 is formed from a beam 205 including a distal end portion 210, an opposing proximal end portion 215, and a pivotal portion 220 positioned therebetween, wherein the pivotal portion 220 is pivotally attached 225 via leg 217 to the planar extension 46, the first planar extension 50, or the second planar extension 60, wherein the pivotal attachment 225 is preferably about one and one-half inches from the surface 40. The alternative embodiment of the control 190 further including a means 245 for biasing the proximal end portion 215 to contact the surface 40. Further, the distal end portion 210 is adapted to be grasped 211 by the user 181, and the proximal end portion 215 is sized and configured to not contact the surface 40 when the distal end portion 210 is grasped 211 in a motion toward 255 the surface 40, wherein the static state 200 occurs when the proximal end portion 215 contacts 250 the surface 40, see FIG. 11, and the moving state 195 occurs when the proximal end portion 215 does not contact 260 the surface 40, see FIG. 12. The means 245 for biasing is preferably a spring as shown in FIGS. 11 and 12, however, the means could be other types of springs such as coil, torsional, and the like, or non-spring means such as a resilient block, or an equivalent.

For the planar extension 46, the first planar extension 50, and the second planar extension 60, the yokes 110, and the nested cantilever platform 135 the preferred materials of construction are aluminum of about one-quarter inch thick, or any other suitable materials. The preferred length of the planar extension 46, the first planar extension 50, or the second planar extension 60 along their respective longitudinal axes being 47, 55, and 65 is about one-hundred and twenty inches, which can be adjustable via the planar extension 46, the first planar extension 50, or the second planar extension 60 being manufactured and attachable in segments. Further, on the planar extension 46, the first planar extension 50, or the second planar extension 60 the cross-sectional shape is that of a channel with a width (perpendicular to the longitudinal axes 47, 55, and 65) of preferably about twelve inches, and a channel sidewall height of about one-one half inches, with other dimensions being acceptable all of the aforementioned dimensions. The preferred length of the transverse members 71 is about forty inches, and can be adjustable lengthwise if needed, as best shown in FIG. 1. Note that the transverse members 71 are removably engagable to the first 50 and second 60 planar extensions in order to selectively set the parallel spaced apart distance of the first 50 and second 60 planar extensions to result in a fixed positional orientation of the first 50 and second 60 planar extensions to one another, again see FIG. 1, thus being operational for the vehicle or article 35 to drive up upon, as best shown in FIG. 13, resulting in retaining the independence of the plurality of rotational elements 90 position to one another from the location or position of the vehicle or article 35. Wherein, the position of the rotational elements 90 to one another is solely determined via the transport apparatus 30 and not the vehicle or article 35.

On the means 80 for bi-directional movement 75, the rotational elements 90 are preferably by manufacturer Darcor being about three inches in diameter by one and three-eighths inch in width 92 being model number W-73-PSE with precision ball bearings having a three-eighths bore with a one and three-quarter hub length, wherein the rotational elements are preferably constructed of solid elastomer, or an equivalent thereof.

### CONCLUSION

Accordingly, the present invention of a transport apparatus has been described with some degree of particularity directed to the embodiments of the present invention. It should be appreciated, though, that the present invention is defined by the following claims construed in light of the prior art so that modifications or changes may be made to the exemplary embodiments of the present invention without departing from the inventive concepts contained therein.

1. A transport apparatus for manually moving a vehicle along a surface, said transport apparatus comprising:
(a) a first planar extension having a first longitudinal axis;
(b) a second planar extension having a second longitudinal axis, wherein said first longitudinal axis and said second longitudinal axis are substantially parallel to one another and said first and second planar extensions are operational to support a vehicle;
(c) a means for a bi-directional movement of said first and second planar extensions along the surface, wherein said movement is along a single axis oriented substantially perpendicular to said first and second longitudinal axes.

2. A transport apparatus for manually moving a vehicle along a surface according to claim 1 wherein said means for bi-directional movement includes a plurality of rotational elements, wherein each said rotational element has a fixed rotational axis sized and configured in relation to said first and second planar extensions, such that each said fixed rotational axis is oriented substantially parallel to said first and second longitudinal axes and the vehicle is supported positionally in-between said plurality of fixed rotational axes and the surface, wherein operationally said plurality of rotational elements facilitate said bi-directional movement.

3. A transport apparatus for manually moving a vehicle along a surface according to claim 2 wherein said means for bi-directional movement further includes a plurality of yokes that are attached to said first and second planar extensions, wherein each said yoke straddles each said rotational element such that each said yoke supports an axle that is co-axial to each said fixed rotational axis, wherein a position of each said fixed rotational axis is such that each said rotational element extends an equal projecting distance beyond said first and second planar extensions in a projected axis substantially perpendicular to the surface in two simultaneous opposing directions.

4. A transport apparatus for manually moving a vehicle along a surface according to claim 3, wherein each said rotating element has an outer periphery that is at least six (6) times a width of each said rolling element, with said width being parallel to said rotational axis.

5. A transport apparatus for manually moving a vehicle along a surface according to claim 4 wherein said plurality of rotational axes are sized and configured to stay in co-axial alignment independent of the vehicle position in relation said first and second planar extensions, being operational to minimize a manual force required to effectuate said bi-directional movement.

6. A transport apparatus for manually moving a vehicle along a surface according to claim 5 further comprising a nested cantilever platform for each of said first and second planar extensions, each said platform is pivotally attached to each of said first and second planar extensions, wherein each said platform includes a shoe portion and an opposing arm portion with said pivotal attachment positioned therebetween, such that each said nested cantilever platform is operational to ease the vehicle upon said first and second planar extensions utilizing said shoe portion in an angled state upon the surface, wherein when the vehicle is fully upon said fist and second planar extensions, the vehicle contacts said arm portion to move said shoe portion from said angled state to a linear state being parallel to said first and second planar extensions, thus lifting said shoe from the surface to facilitate said bi-directional movement.

7. A transport apparatus for manually moving a vehicle along a surface according to claim 1 further comprising a means for automatic conditional substantial restriction of said bi-directional movement.

8. A transport apparatus for manually moving a vehicle along a surface according to claim 7 wherein said means for automatic conditional substantial restriction of said bi-directional movement is a control adjacent to said first planar extension that must have a grasp by a user for said bi-directional movement to occur in a moving state of said transport apparatus, wherein the user releasing said grasp of said control results in a substantial restriction of said bi-directional movement from occurring in a substantially static state of said transport apparatus.

9. A transport apparatus for manually moving a vehicle along a surface according to claim 8 wherein said control is formed from a beam including a distal end portion, an opposing proximal end portion, and a pivotal portion positioned therebetween, wherein said pivotal portion is pivotally attached to said first planar extension, said distal end portion is adapted to be grasped by the user, and said proximal end portion is sized and configured to contact the surface when said distal end portion is grasped in a motion away from the surface, wherein a distance between said first planar extension and the surface is increased and then decreased a lesser amount to manually urge said beam into a substantially locked state ceasing said motion equating to said static state.

10. A transport apparatus for manually moving a vehicle along a surface according to claim 8 wherein said control is formed from a beam including a distal end portion, an opposing proximal end portion, and a pivotal portion positioned therebetween, wherein said pivotal portion is pivotally attached to said first planar extension, further including a means for biasing said proximal end portion to contact the surface, said distal end portion is adapted to be grasped by the user, and said proximal end portion is sized and configured to not contact the surface when said distal end portion is grasped in a motion toward the surface, wherein said static state occurs when said proximal end portion contacts the surface and said moving state occurs when said proximal end portion does not contact the surface.

11. A transport apparatus for manually moving a vehicle along a surface, said transport apparatus comprising:
(a) a planar extension having a longitudinal axis, wherein said planar extension is operational to support a vehicle; and
(b) a means for a bi-directional movement of said planar extension along the surface, wherein said movement is along a single axis oriented substantially perpendicular to said longitudinal axis.

12. A transport apparatus for manually moving a vehicle along a surface according to claim 11 wherein said means for bi-directional movement includes a plurality of rotational elements, wherein each said rotational element has a fixed rotational axis sized and configured in relation to said planar extension, such that each said fixed rotational axis is oriented substantially parallel to said longitudinal axis and the vehicle is supported positionally in-between said plurality of fixed rotational axes and the surface, wherein operationally said plurality of rotational elements facilitate said bi-directional movement.

13. A transport apparatus for manually moving a vehicle along a surface according to claim 12 wherein said means for bi-directional movement further includes a plurality of yokes that are attached to said planar extension, wherein each said yoke straddles each said rotational element such that each said yoke supports an axle that is co-axial to each said fixed rotational axis, wherein a position of each said fixed rotational axis is such that each said rotational element extends an equal projecting distance beyond said planar extension in a projected axis substantially perpendicular to the surface in two simultaneous opposing directions.

14. A transport apparatus for manually moving a vehicle along a surface according to claim 13, wherein each said rotating element has an outer periphery that is at least six (6) times a width of each said rolling element, with said width being parallel to said rotational axis.

15. A transport apparatus for manually moving a vehicle along a surface according to claim 14 wherein said plurality of rotational axes are sized and configured to stay in co-axial alignment independent of the vehicle position in relation said planar extension, being operational to minimize a manual force required to effectuate said bi-directional movement.

16. A transport apparatus for manually moving a vehicle along a surface according to claim 15 further comprising a nested cantilever platform for said planar extension, said platform is pivotally attached to said planar extension, wherein said platform includes a shoe portion and an opposing arm portion with said pivotal attachment positioned therebetween, such that said nested cantilever platform is operational to ease the vehicle upon said planar extension utilizing said shoe portion in an angled state upon the surface, wherein when the vehicle is fully upon said planar extension, the vehicle contacts said arm portion to move said shoe portion from said angled state to a linear state being parallel to said planar extension, thus lifting said shoe from the surface to facilitate said bi-directional movement.

17. A transport apparatus for manually moving a vehicle along a surface according to claim 11 further comprising a means for automatic conditional substantial restriction of said bi-directional movement.

18. A transport apparatus for manually moving a vehicle along a surface according to claim 17 wherein said means for automatic conditional substantial restriction of said bi-directional movement is a control adjacent to said planar extension that must have a grasp by a user for said bi-directional movement to occur in a moving state of said transport apparatus, wherein the user releasing said grasp of said control results in substantial restriction said bi-directional movement from occurring in a substantially static state of said transport apparatus.

19. A transport apparatus for manually moving a vehicle along a surface according to claim 18 wherein said control is formed from a beam including a distal end portion, an opposing proximal end portion, and a pivotal portion positioned therebetween, wherein said pivotal portion is pivotally attached to said planar extension, said distal end portion is adapted to be grasped by the user, and said proximal end portion is sized and configured to contact the surface when said distal end portion is grasped in a motion away from the surface, wherein a distance between said planar extension and the surface is increased and then decreased a lesser amount to manually urge said beam into a substantially locked state ceasing said motion equating to said static state.

20. A transport apparatus for manually moving a vehicle along a surface according to claim 18 wherein said control is formed from a beam including a distal end portion, an opposing proximal end portion, and a pivotal portion positioned therebetween, wherein said pivotal portion is pivotally attached to said first planar extension, further including a means for biasing said proximal end portion to contact the surface, said distal end portion is adapted to be grasped by the user, and said proximal end portion is sized and configured to not contact the surface when said distal end portion is grasped in a motion toward the surface, wherein said static state occurs when said proximal end portion contacts the surface and said moving state occurs when said proximal end portion does not contact the surface.
